(19) United States
(12) Patent Application Publication
(10) Pub. No.: US 2007/0236845 A1
(43) Pub. Date: Oct. 11, 2007

(54) Open neutral detection circuit

(76) Inventor: Mark Swint, Tuscumbia, AL (US)

Correspondence Address: SIROTE & PERMUTT, P.C., P.O. BOX 55727, 2311 HIGHLAND AVENUE SOUTH, BIRMINGHAM, AL, 35255-5727, US

(21) Appl. No.: 11/400,999

(22) Filed: Apr. 10, 2006

(51) Int. Cl. H02H 3/00

(52) U.S. Cl. 361/78

(57) ABSTRACT

An open neutral sensing circuit includes a first sensing resistance contacting a first line and a neutral. A second sensing resistance contacts a second line and the neutral and has a value greater than the first sensing resistance. A control switch contacts the first line and the neutral. The control switch is configured to switch from a first state to a second state when the voltage drop across the first sensing resistance is equal to the voltage drop across the second sensing resistance.

### FIELD OF THE INVENTION

The present invention relates generally to circuits used in power sensing applications. More particularly, the present invention relates to circuits used for detecting open neutral configurations in power circuits for recreational vehicles.

### BACKGROUND OF THE INVENTION

Recreational vehicles (RVs) use the same type of power as residential housing. Namely, both recreational vehicles and residential housing are supplied by public utility power (240/120 VAC). For example, as shown in FIG. 1, a normal utility source at a breaker panel 12 includes four lines: L1 line 14, L2 line 16, neutral 18 and ground 20. The voltage difference between the L1 line 14 and the L2 line 16 is 240 volts. The difference between each of the L1 line and L2 line 14 and 16 and the neutral line 18 is 120 volts. As power flows from L1 line and L2 line 14 and 16 to the neutral, the voltage drop will be 120 volts. Such a system is the common configuration for both residential housing and RVs. RVs, however, may also be powered by diesel or gas generators that can be used to power the 240/120 VAC of the RV if utility power is not available. Because of this difference, and because an RV is mobile and must plug-in to utility power when the RV stops, the connections which are hard wired in residential housing require the use of a multi-pronged plug for RVs.

When a generator is used to supply power, it is necessary to inhibit the flow of power to the utility power grid. In order to minimize the risk of putting power from the generator into the power grid, a switch over box switches from utility power to generator power. A common switch over box 28 is shown in FIG. 2. The switch over box 28 includes L1 line 30, L2 line 32, and two neutral lines 34. Line contactors C1 36 and neutral contactors C2 38 mechanically couple the power sources (utility source and generator source, respectively) to an AC main panel 40. A transfer delay board 42 delays power to the main panel from the generator source and converts the AC power from the generator source to a DC current. A line coil 44 actuates the line contactors 36. An auxiliary contactor 46 is also controlled by the line coil 44. A neutral coil 48 actuates the neutral contactors 38.

In one embodiment, the line contactors 36 are 50 Amp rated contactors while the line coil 44 which actuates the line contactors 36 is a 125 VDC coil. The neutral contactors 38 are 50 Amp rated contactors while the neutral coil 46 which actuates the neutral contactors 38 is a 125 VAC coil.

When power is supplied from the generator source, the transfer delay board 42 delays the opening and closing of the line contactors 36 and the neutral contactors 38, generally for 15 to 20 seconds so that the generator source may stabilize. Once the delay has passed, the line coil 44 is energized, and opens the line contactors 36 on the lines 30 and 32 from the utility and closes the line contactors 36 on the lines 30 and 32 from the generator. The line coil 44 also closes the auxiliary contactor 46 so that power will flow to the neutral coil 48. When the neutral coil 48 is energized, the neutral contactors 38 change state and power flows from the generator to the AC main power panel 40. When the generator is turned off, the coils 44 and 48 are de-energized and power flows from utility to the AC main power panel 40 as the line contactors 36 and neutral contactors 38 which are normally closed are returned to a closed state and the de-energized line contactors 36 and neutral contactors 38 which are normally open are returned to an open state.

The use of a mechanical connection to the utility power grid creates potential problems over time as the mechanical connections tend to degrade or erode causing an unreliable power source. It is also possible that the power plug may be improperly inserted into the utility supply receptacle. When either problem exists, an open neutral condition may occur. An open neutral condition can allow the full voltage differential between lines L1 and L2, that is 240 VAC, to be applied to all devices within an RV. Many devices within an RV are designed only for 120 VAC sources. When 120 VAC devices are energized with 240 VAC supplies, failure of the devices and possible injury to the RV and the owner may occur, including the ignition of RV materials.

### SUMMARY OF THE INVENTION

An open neutral sensing circuit, comprising a first sensing resistance contacting a first line and a neutral; a second sensing resistance contacting a second line and the neutral having a value greater than the first sensing resistance; and a control switch contacting the first line and the neutral configured to switch from a first state to a second state when the voltage drop across the first sensing resistance is equal to the voltage drop across the second sensing resistance.

### BRIEF DESCRIPTION OF THE DRAWINGS

FIG. 1 is a diagram of a utility power source;

FIG. 2 is a diagram of a change over box;

FIG. 3A is a diagram of a closed neutral circuit;

FIG. 3B is a diagram of an open neutral circuit;

FIG. 4 is a diagram of a change over box according to one aspect of the invention;

FIG. 5A is a diagram of a closed neutral circuit with a change over box according to another aspect of the invention; and,

FIG. 5B is a diagram of an open neutral circuit with a change over box according to another aspect of the invention.

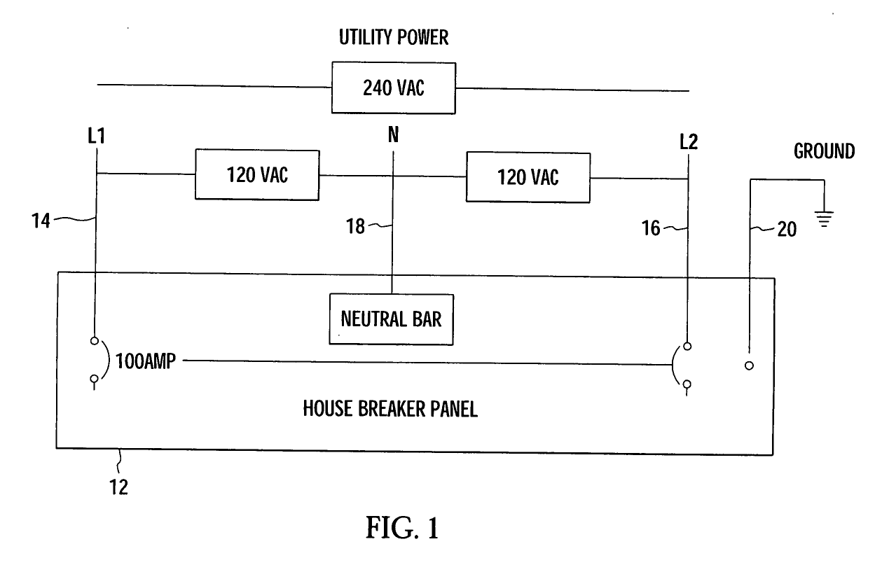

### DETAILED DESCRIPTION OF THE INVENTION

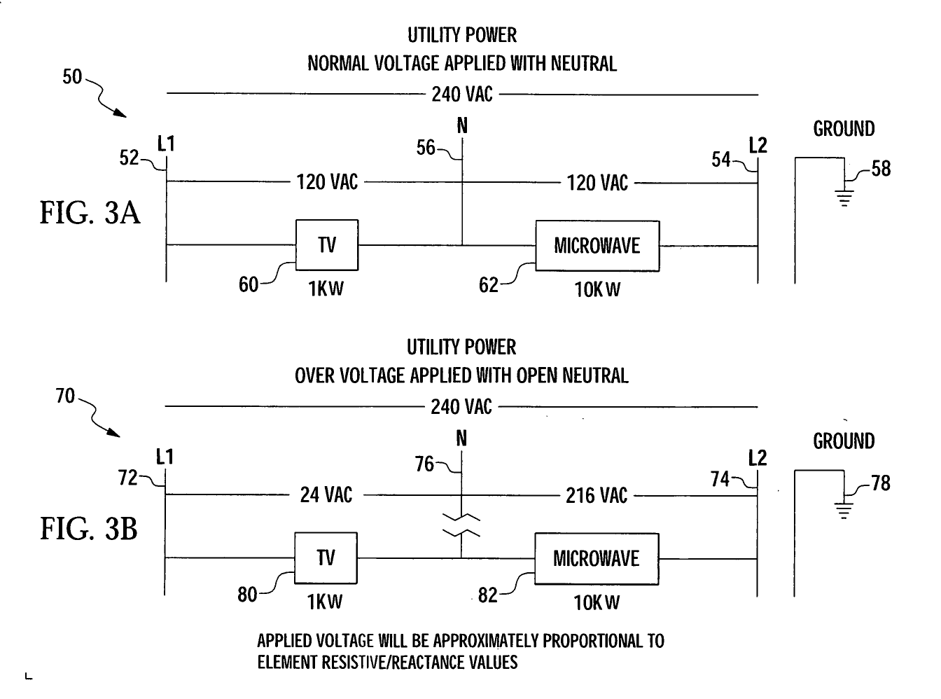

Turning now to FIGS. 3A and 3B, FIG. 3A is a diagram of a closed neutral circuit 50 inside the RV. Four lines, L1 52, L2 54, neutral 56, and ground 58 provide power to the RV. As an example, a TV 60 and a microwave 62 are in the RV and powered by a portion of the circuit 50. In this example, the TV 60 is connected between the L1 line 52 and the neutral 56. The microwave 62 is connected to the L2 line 54 and the neutral 56. The resistive loads for the TV 60 and the microwave 62 are 1 kW and 10 kW respectively. When the neutral is properly closed, the TV 60 and the microwave 62 are on different circuits, and the relative differences in the resistive loads are inconsequential to the operation of the TV 60 and the microwave 62.

Turning now to FIG. 3B, an open neutral circuit 70 inside the RV. The same four lines, L1 72, L2 74, neutral 76, and ground 78 provide power to the RV. However, because of the problem with the connection to the utility power, the neutral 76 is open. A TV 80 and a microwave 82 are in the RV and powered by the circuit 70. In this example, the TV 80 is connected between the L1 line 72 and the open neutral 76. The microwave 82 is connected to the L2 line 54 and the neutral 56. The resistive loads for the TV 80 and the microwave 82 are 1 kW and 10 kW respectively. When the neutral is open, the TV 80 and the microwave 82 are on the same circuit, and the relative differences in the resistive loads change the voltage drop across the loads.

Power cannot flow from the L1 line 72 and the L2 line 74 to neutral 76. Instead, the power flows from L1 line 72 to the L2 line 74, and the voltage drop between L1 line 72 to the L2 line 74 will be 240 VAC. Because the loads are in series, the voltage drop across the TV 82 and the microwave 84 will total 240 VAC. Thus, the drop across the TV 80 will be 24 VAC while the drop across the microwave 82 will be 216 VAC. The voltage across the microwave 82 may overload the microwave 82 and the voltage drop across the TV 80 may also damage the TV 80.

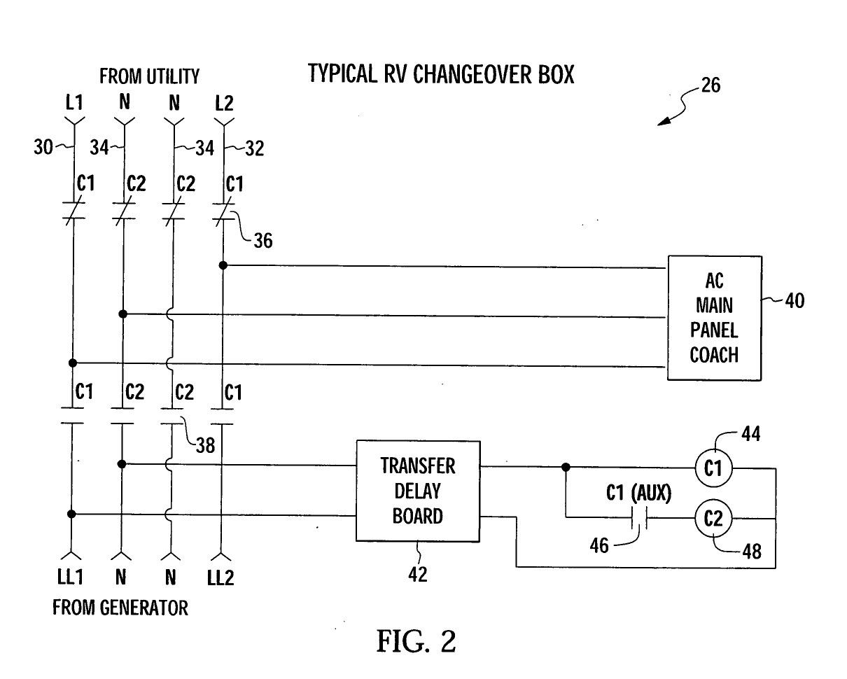

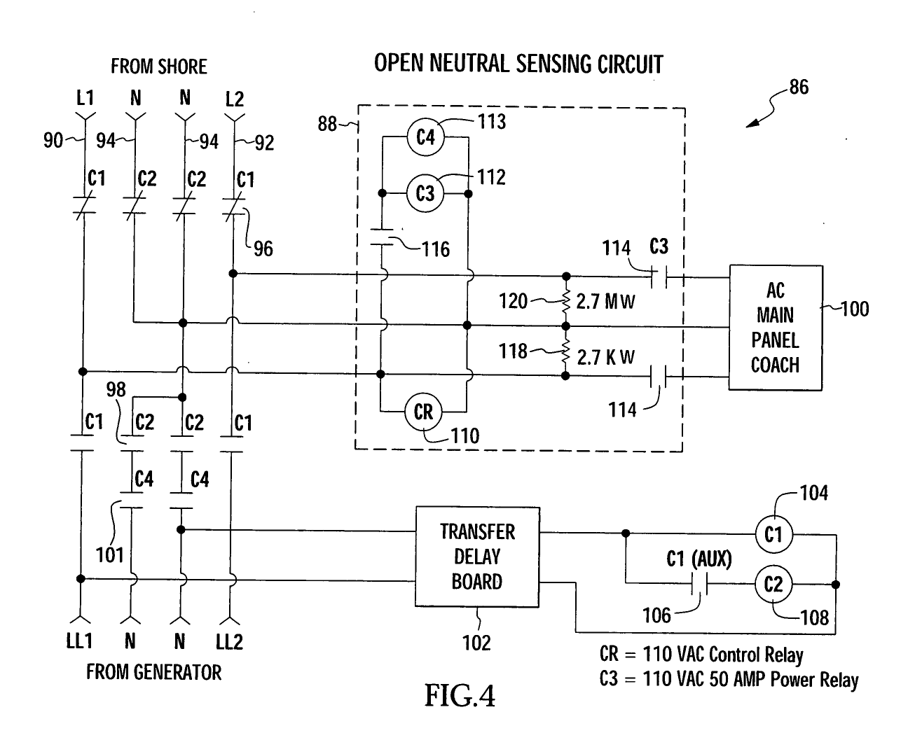

Turning now to FIG. 4, FIG. 4 is a diagram of a change over box 86 according to an aspect of the invention. The change over box 86 of FIG. 4 is similar to the changeover box of FIG. 2, except an open neutral sensing circuit 88 is placed between the power sources and the RV. The operation of switching from utility power to generator power is the same.

The switch over box 86 includes L1 line 90, L2 line 92, and neutral lines 94. Line contactors C1 96 and neutral contactors C2 98 mechanically couple the power sources (utility source and generator source, respectively) to an AC main panel 100. A pair of secondary neutral contactors 101 couple the neutral lines 94 to the generator source. A transfer delay board 102 delays power to the main panel from the generator source and converts the AC power from the generator source to a DC current. A line coil 104 actuates the line contactors 96. An auxiliary contactor 106 is also controlled by the line coil 104. A neutral coil 108 actuates the neutral contactors 98.

In one embodiment, the line contactors 96 are 50 Amp rated contactors while the line coil 104 which actuates the line contactors 96 is a 125 VDC coil. The neutral contactors 98 are 50 Amp rated contactors while the neutral coil 106 which actuates the neutral contactors 98 is a 125 VDC coil.

When power is supplied from the generator source, the transfer delay board 102 delays the closing of the neutral contactors 98, generally for 15 to 20 seconds. Once the delay has passed, the line coil 104 is energized, and switches the state of the line contactors 96, opening the normally closed line contactors 96 and closing the normally open line contactors 96. The coil 104 also closes the auxiliary contactor 106 so the power will flow to the neutral coil 108. When the neutral coil 108 is energized, the neutral contactors 98 switch states, opening the normally closed neutral contactors 98 and closing the normally open neutral contactors 98. Power flows from the generator to the AC main power panel 100. When the generator is turned off, the coils 104 and 108 are de-energized and power flows from utility to the AC main power panel 100 as the line contactors 96 and the neutral contactors 98 which are normally closed are returned to the closed state and the de-energized neutral contactors 98 and the line contactors 96 which are normally open are returned to the open state.

Regardless of the source of power, the power flows from the power source to the AC main power panel 100 through the open neutral sensing circuit 88. The open neutral sensing circuit 88 includes a control relay 110, a power relay 112, a neutral relay 113, a pair of normally open power actuators 114, a normally open control actuator 116, a high load resistor 118 and a low load resistor 120. The low load resistor 120 is placed between the neutral 94 and the L1 line 90. The high load resistor 118 is placed between the neutral 94 and the L2 line 92. One of the normally open power actuators 114 is placed on the L1 line 90, and the other normally open power actuator 114 is placed on the L2 line 92. The control relay 110 is placed between the neutral 94 and the L1 line 90, and is parallel to the low load resistor 118. The normally open control actuator 116 and the power relay 112 are placed in series between the neutral 94 and the L2 line 92, and are parallel to the high load resistor 118. The neutral relay 113 is placed parallel to the power relay 112.

The open neutral sensing circuit 88 senses an open neutral by measuring the voltage drop across the load resistors 118 and 120. When the neutral 94 is closed (i.e., properly attached to the power source and AC main panel 100), the voltage drop across both load resistors 118 and 120 is 120 VAC. The control relay 110 is energized and the relay closes the normally open control actuator 116. When the normally open control actuator 116 closes, then power flows to the power relay 112 and the normally open power actuators 114 close. Power then flows from the power source to the AC main panel 100.

When the neutral 94 is open, the voltage drop across the low load resistor 118 is too small to actuate the control relay 110. Because the control relay 110 does not close the normally open control actuator 116, the power relay 112 does not energize and power does not flow to the AC main panel 100. The neutral relay 113 is placed in parallel to the power relay 112 to close the neutral lines 94 to the generator when the neutral is properly sensed. The neutral relay 113 keeps the neutral 94 of the generator from interfering with the neutral of the generator.

As an example, the resistive loads 118 and 120 may be set to 270 kOhms and 2.7 MOhms. The ten fold difference in resistance between the two loads 118 and 120 allows the voltage drop difference between the low load resistor 118 and the high load resistor 120 to be markedly different when the neutral 94 is open. Moreover, by setting the resistances 118 and 120 relatively high to the resistances inside the RV, the current to the AC main panel 100 will be minimally effected by the open neutral sensing circuit 88.

The control relay 110 may be chosen as a 110 VAC relay. This allows the control relay 110 to close when the voltage drop across the low load resistor 118 is at least 110 VAC. Such a condition exists only when the neutral 94 is closed. The power relay 112 and neutral relay 113 may also be a 110 VAC relay. Because the power relay 112 closes contactors 114 that are placed along the L1 line 90 and the L2 line 92, the power relay should be rated to high currents. In this example, the relay 112 is rated to 50 Amps. The neutral relay 113

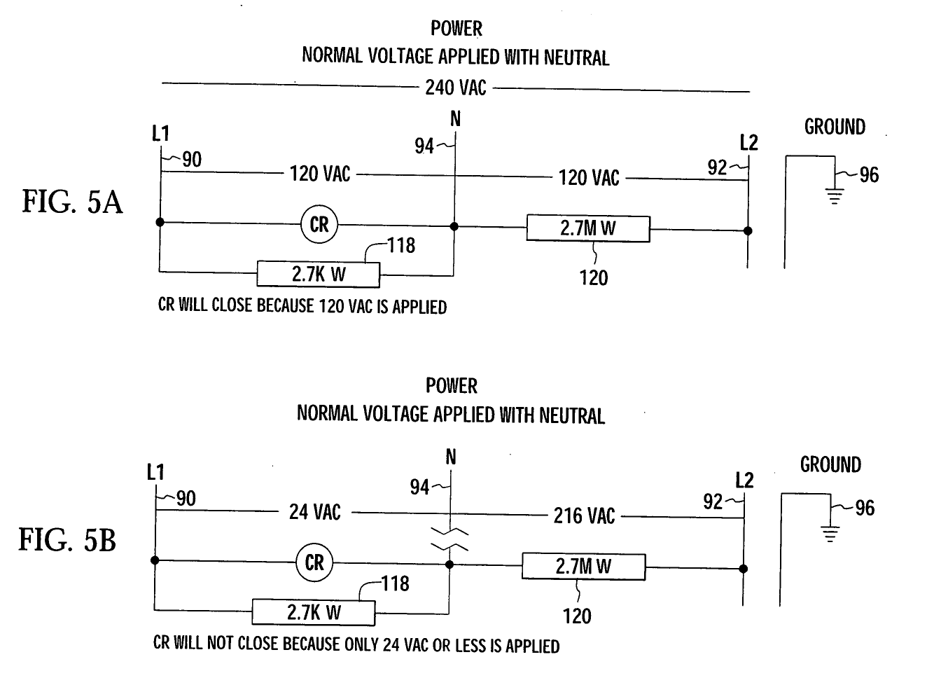

Turning now to FIGS. 5A and 5B, FIG. 5A is a diagram of the closed neutral circuit with a change over box according to an aspect of the invention. Using the values from the example of FIG. 4, the voltage drops across the resistances 118 and 120 are 120 VAC when the neutral is closed. The control relay 110 will close, and operation to the AC main panel 100 is normal. In FIG. 5B, an open neutral circuit with the change over box according to an aspect of the invention is shown. When the neutral 94 is open, then the voltage drop across the low load resistor 118 is approximately 218.2V while the drop across the high load resistor is 216 VAC. The small voltage drop across the low load resistor 118 is not enough to energize the control relay 112, and power will not flow from the power source to the AC main panel 100.

While the invention has been shown in embodiments described herein, it will be obvious to those skilled in the art that the invention is not so limited but may be modified with various changes that are still within the spirit of the invention.

Having set forth the nature of the invention, what is claimed is:

1. An open neutral sensing circuit, comprising:
a. a first sensing resistance contacting a first line and a neutral;
b. a second sensing resistance contacting a second line and said neutral having a value greater than said first sensing resistance; and
c. a control switch contacting said first line and said neutral configured to switch from a first state to a second state when the voltage drop across said first sensing resistance is equal to the voltage drop across said second sensing resistance.

2. The open neutral sensing circuit of claim 1, wherein said control switch is a control relay.

3. The open neutral sensing circuit of claim 2, wherein said control relay is a normally open relay such that said first state is normally open and said second state is normally closed.

4. The open neutral circuit of claim 3, further comprising a power switch contacting said first line and said control relay such that when said control relay is energized, said power switch switches from a first state to a second state.

5. The open neutral sensing circuit of claim 4, wherein said power switch is a relay.

6. The open neutral sensing circuit of claim 5, wherein said power relay is a normally open relay such that said first state is normally open and said second state is normally closed.

7. The open neutral sensing circuit of claim 6, wherein said power relay is configured such that power is passed from a power source to an AC breaker panel when said power relay is in said normally closed state.

8. The open neutral sensing circuit of claim 7, wherein said AC breaker panel is in a recreational vehicle.

9. The open neutral sensing circuit of claim 1, wherein said circuit is in a switch over box for a recreational vehicle.

10. The open neutral sensing circuit of claim 9, wherein said switch over box is configured to attach to a power utility plug.

11. The open neutral sensing circuit of claim 9 wherein said switch over box is configured to attach to a generator.

12. A method for detecting an open neutral condition in a circuit, comprising the steps of:
a. detecting a first voltage drop between a first line and a neutral;
b. detecting a first voltage drop between a second line and said neutral; and
c. comparing said first voltage drop to said second voltage drop such that when said first voltage drop is less than said second voltage drop, then an open neutral has been detected.

13. The method of claim 12, further comprising the step of switching a power switch from a first power state to a second power state so that power may flow from said first line and said second line to an AC breaker panel when said first voltage drop is equal to said second voltage drop.

14. The method of claim 13, further comprising the step of switching a control switch from a first control state to a second control state when said first voltage drop is equal to said second voltage drop such that closing said control switch switches said power switch from said first power state to said second power state.

15. The method of claim 12, wherein said first line and said second line are supplied by utility power.

16. The method of claim 12, wherein said first line and said second line are supplied by a generator.

17. A switch over box for a recreational vehicle, comprising:
a. a plug for connecting a breaker panel in the recreational vehicle to utility power;
b. a sensing circuit configured to detect an open neutral condition between said plug and said recreational vehicle, such that said sensing circuit is configured to pass power from said plug to said recreational vehicle when said sensing circuit detects a closed neutral.

18. The switch over box of claim 17, wherein said sensing circuit comprises:
a. means for sensing a first voltage drop between a first line and a neutral;
b. means for sensing a second voltage drop between a second line and said neutral; and
c. means for switching from a first state to a second state when said first voltage drop is equal to said second voltage drop.

19. The switch over box of claim 17, wherein said means for switching further includes means for switching a normally open contact to a normally closed contact when said first voltage drop is equal to said second voltage drop.

20. The switch over box of claim 19, wherein said plug is configured to attach to a generator.
